(19) United States
(12) Patent Application Publication
(10) Pub. No.: US 2008/0247749 A1
(43) Pub. Date: Oct. 9, 2008

(54) Camera Wrap Cover

(76) Inventors: David Law, Seattle, WA (US); Ryan Mongan, Sammamish, WA (US); Xio Lei, Shanghai (CN)

Correspondence Address: MAXVALUEIP CONSULTING, 11204 ALBERMYRTLE ROAD, POTOMAC, MD, 20854, US

(21) Appl. No.: 11/695,624

(22) Filed: Apr. 3, 2007

(51) Int. Cl. G03B 17/02; B65D 85/38

(52) U.S. Cl. 396/535; 206/316.1; 361/681

(57) ABSTRACT

Currently, there are many compact cameras from multiple vendors. These come in all shapes and sizes. The majority of the cases (e.g. for protection, security, and safety) on the market are generic loose-fitting cut-and-sew products. The camera is stowed in the case and then brought out to take a picture. The person then has to find a place to put the case while they take the picture and often the case becomes misplaced or damaged (e.g. by water or dirt). The solution that we are showing is a wrapping cover which is permanently attached to the camera (as one example), to protect the camera, for example. The cover wraps around the camera and forms a very close fitting protective cover for the camera. Because the user wraps the material around the camera, the size of the cover is as small as possible (for better stowing in pockets and purses (for better mobility and more convenience)). There are no extra air spaces because of a generically sized cover (in this example). The wrap cover is attached full-time to the bottom of the camera, using the standard tripod mounting hole that exists on the majority of cameras. When there is no mounting hole, there is a hook, ring, or similar attachment device that can perform the same function. When the person wants to take a picture, he/she simply unwraps the wrap cover, which then hangs below the camera, and then he/she takes the photograph. Other variations are also discussed.

### BACKGROUND

Currently, there are many compact cameras from multiple vendors. These come in all shapes and sizes. Currently, the majority of the cases (e.g. for protection, security, fashion, convenience, and safety) on the market are generic loose-fitting cut-and-sew products. The camera is stowed in the case and then brought out to take a picture. The person then has to find a place to put the case while they take the picture and often the case becomes misplaced or damaged (e.g. by water or dirt).

Some of the prior art are listed here:
U.S. Pat. No. 7,180,735, by Thomas, et al., teaches a protective enclosure and watertight adapter for an interactive flat-panel controlled device, including the hinge.
U.S. Pat. No. 5,173,585, by Dokken, teaches a camera heating jacket, with the heating element.

### SUMMARY

The solution that we are showing is a wrapping cover which is permanently attached to the camera (as one embodiment), to protect the camera, for example. The cover wraps around the camera and forms a very close fitting protective cover for the camera. Because the user wraps the material around the camera, the size of the cover is as small as possible (for better stowing in pockets and purses (for better mobility and more convenience)). There are no extra air spaces because of a generically sized cover (in this example). The wrap cover is attached full-time to the bottom of the camera, using the standard tripod mounting hole that exists on the majority of cameras. When there is no mounting hole, there is a hook, ring, or similar attachment device that can perform the same function.

When the person wants to take a picture (or alternatively, for accessing other parts or functionalities), he/she simply unwraps the wrap cover, which then hangs below the camera. When the user finishes working with the camera, then the user can rewraps the camera. She never loses her cover, is able to take pictures more quickly, and has the smallest (most form-fitting) case that is possible.

### BRIEF DESCRIPTION OF THE DRAWINGS

FIG. 1 shows some of the examples and features of the current invention.

FIG. 2 shows an example, using magnetic pieces, to hold up the wrap in place.

FIG. 3 shows an example, using Velcro and rubber.

FIG. 4 shows an example of how to open and close the wrap (cover).

FIG. 5 shows an example of a typical unit.

FIG. 6 shows an example of a typical unit, in another view/angle.

FIG. 7 shows an example of a typical unit, in another view/angle.

FIG. 8 shows an example of a typical unit, in another view/angle.

FIG. 9 shows an example of a typical unit, in another view/angle.

FIG. 10 shows an example of a typical unit, in another view/angle.

FIG. 11 shows an example of a short leg support, with a metal plate, and its corresponding adjusting mechanism underneath, to adjust the setting, and cover different sizes of cameras, using the wrap.

FIG. 12 shows an example of the wrap, with a short leg support attached.

FIG. 13 shows an example of the wrap, with a short leg support attached.

### DETAILED DESCRIPTION OF THE PREFERRED EMBODIMENTS

The wrap accommodates multiple camera sizes. It is wide enough to accommodate the majority of cameras, and simply extends a little beyond the sides of the camera. When using a stretchy material for the wrap, the material stretches around the sides of the camera and protects the sides of the camera also. A rubber band can shrink the openings at the two ends, to reduce the exposure of the camera to outside elements, such as cold, hot, moisture, dirt, rain, or impact. Also, alternatively, a zipper or other devices (e.g. strings) can be used to completely seal off the openings on either or both sides. In another embodiment, no open side is restricted by any method or devices.

One embodiment uses a stretch material or Velcro, a material that has recently become more prevalent in the market. This material is stretchy and soft, and offers a good feeling and protectiveness. When wrapped around the camera, it will accommodate multiple sizes and the non-stretchy hook portion of the Velcro can attach at any place around the wrap.

In one embodiment, the chain, hook, belt, adjustable belt, cable, string, tether, tie, binding means, magnet, screw, nut, nail, glue, temporary glue, knot, friction-based connector, connection means, elastic band, two extremely smooth surfaces, electrostatic force, or electromagnetic force is used for closing the wrap around the camera, or used to connect the wrap to the camera.

In one embodiment, one can add a belt clip to the wrap (called “Armadillo”), so that it could be worn on the belt. Also, the wrap itself (without any additional parts) can be wrapped over a belt, so that it can be worn by a user on his belt. Also, the wrap can be attached to the belt, pants, skirt, shirt, or purse, with a string, tether, band, belt, or chain, through the wrap, on the wrap, in-between the wrap, or inside the wrap.

In one embodiment, one can add different designs, text, and patterns inside or outside of the wrap for decoration, advertisement, instructions, or convenience of the user.

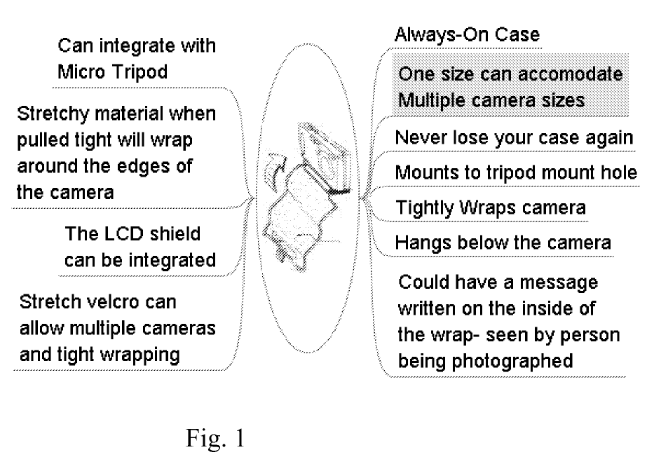

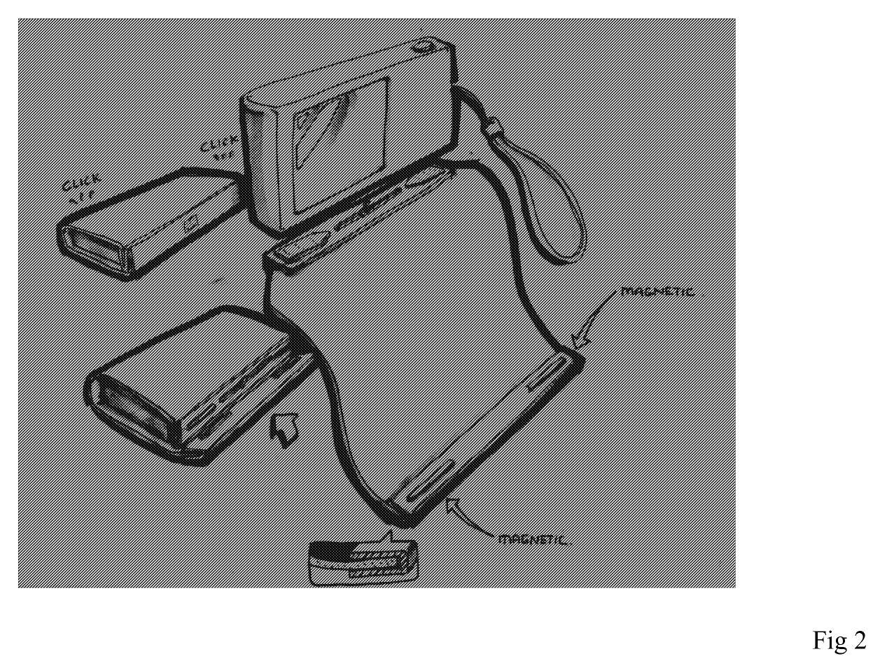

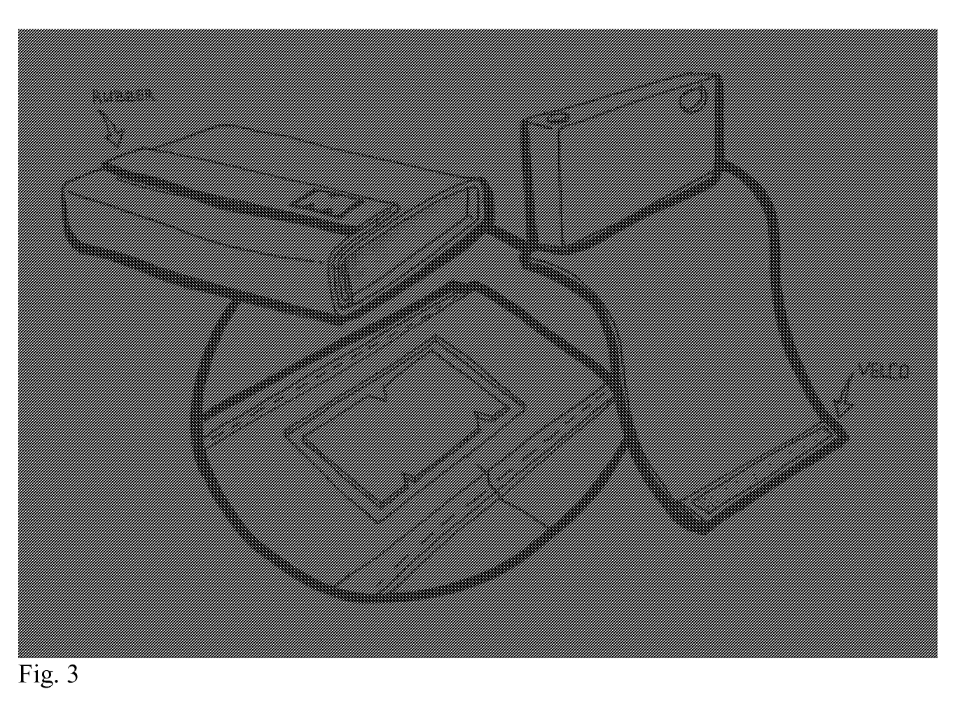

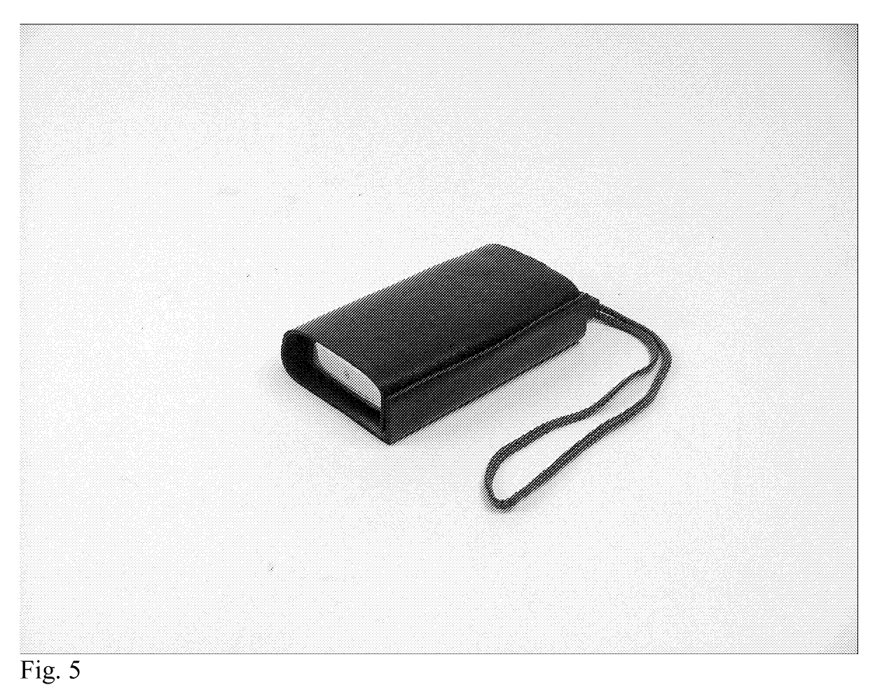

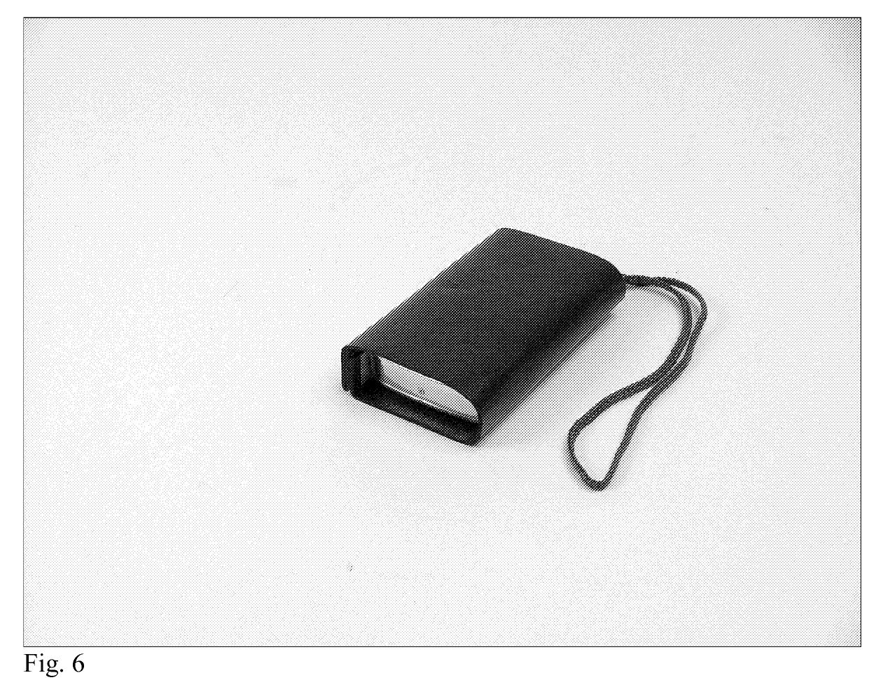

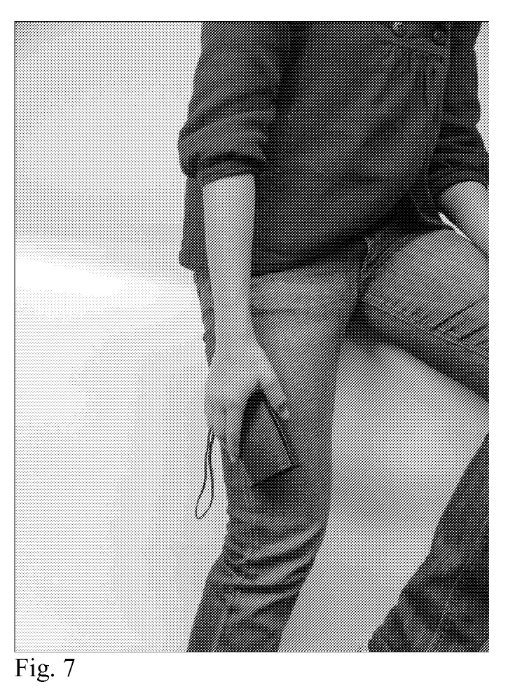

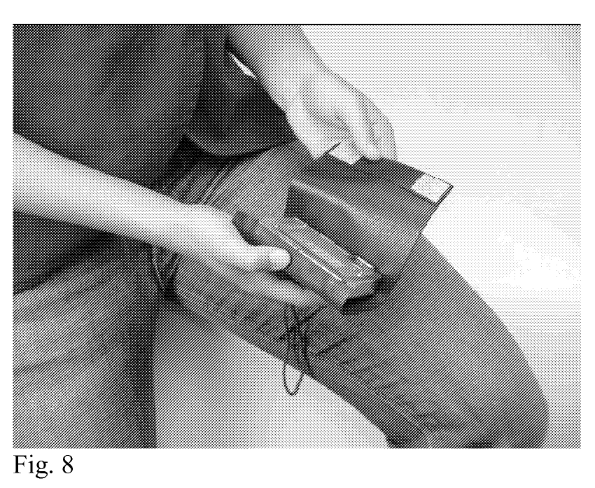

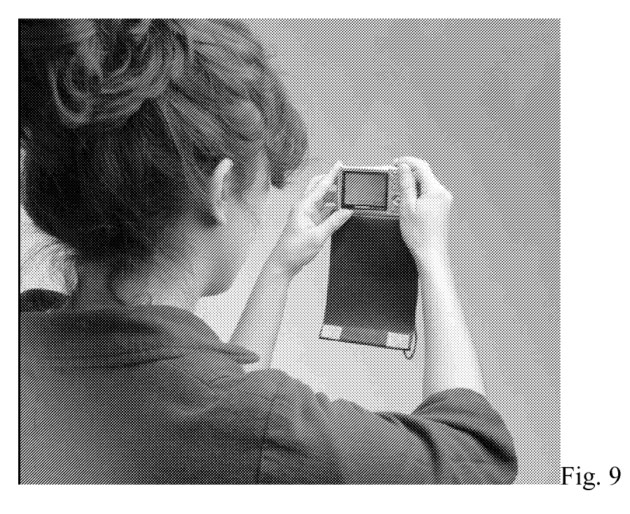

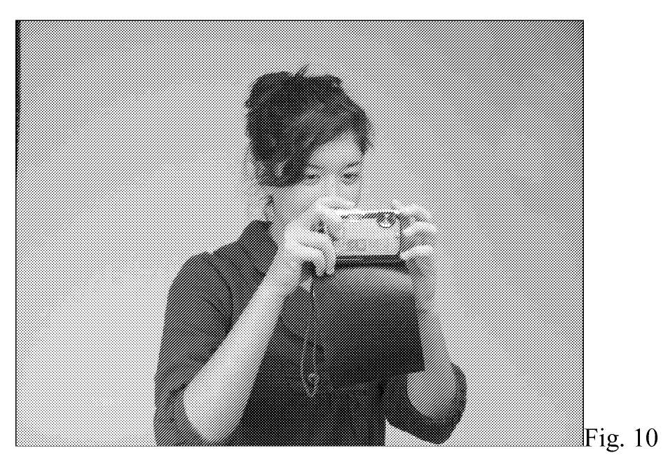

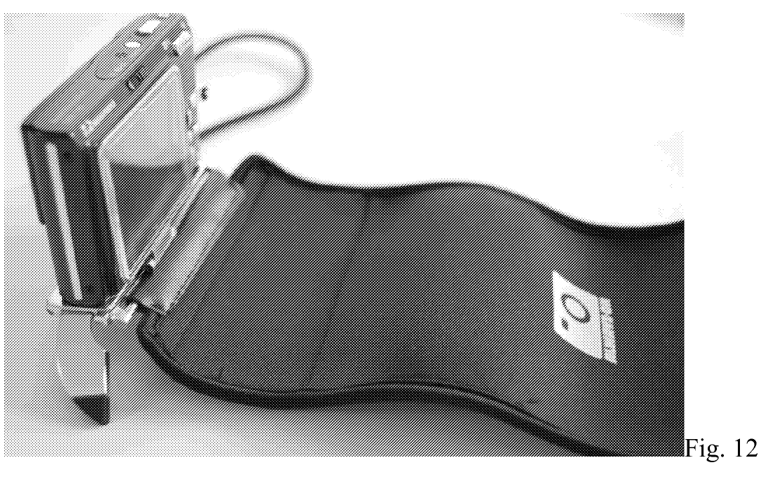

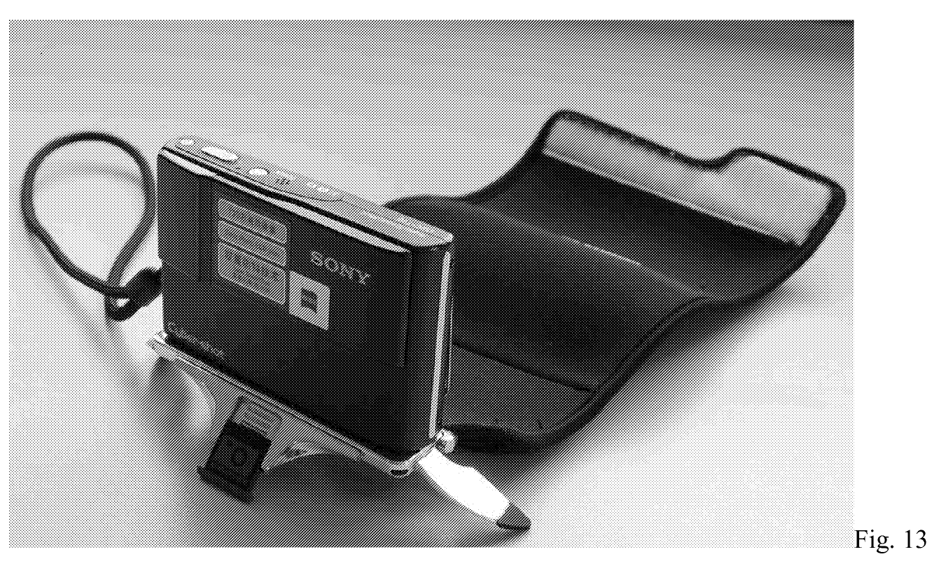

FIGS. 1-13 are examples of different features and views of the unit.

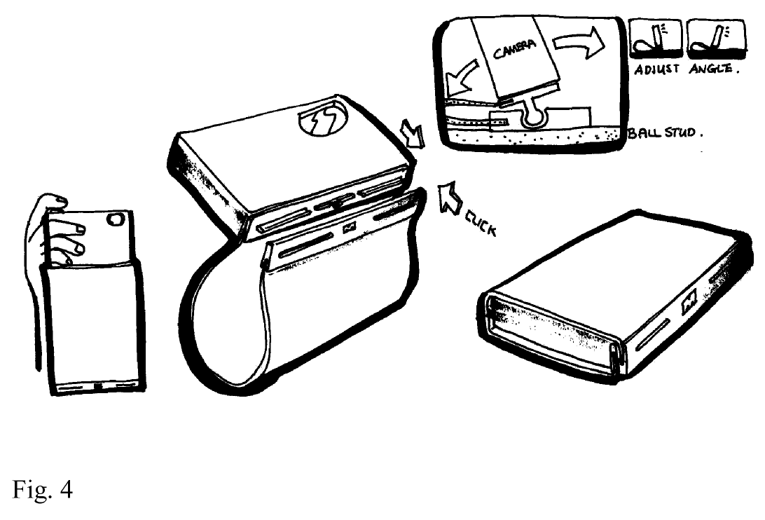

In FIG. 4, one can use different variations for wrap, with respect to the base plate, located under the camera. (In general, the base plate can be on any side of the camera.) One example is a bag, where it can be inverted, inside-out, and pulled up, to cover the camera, where the bag can also be closed off, using a rubber band, elastic band, button, plastic zipper, zipper, or string, for example.

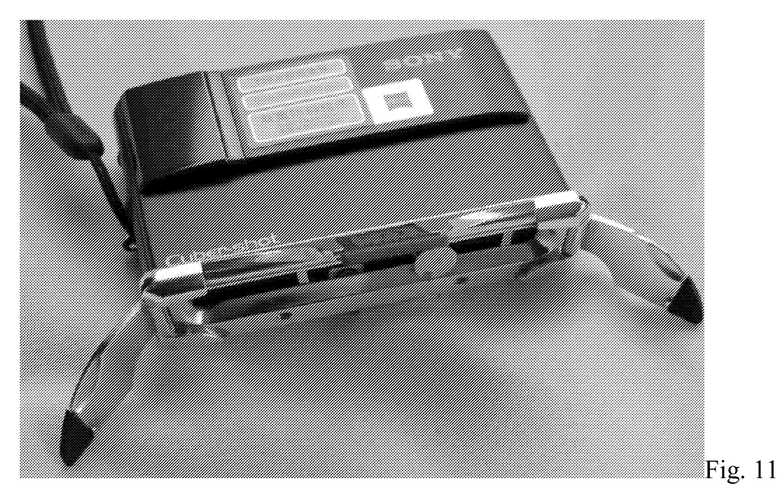

As shown in FIG. 11, part of the ability to adapt to many cameras is to adjust the screw mounting point, underneath the assembly (as an embodiment). The tripod mount hole moves all over the bottom of the camera. (Without the ability to move the screw point on the bottom setup, the wrap would only fit on a very limited number of cameras and camera sizes.) FIG. 11 shows a simple slot for the screw, but, in general, it could also include many holes, railings, slots, and screws, with multidimensional adjustments, based on angular, azimuth, and/or 3 perpendicular axes, in 3 orthogonal directions (as an embodiment), in cylindrical, spherical, or Cartesian coordinates.

In one embodiment, we are presenting a camera cover which wraps around the camera and stays connected to the camera at all times. In another embodiment, this wrap can be separated from the camera, if the user chooses so. In one embodiment, this is a protective wrap for compact cameras. However, in other embodiments, it can be used for any camera, any size, and with any type of lens assembly. This includes the cell phone cameras and cameras installed, assembled, embedded, or hidden in any other objects or items.

Other embodiments/examples: The lens cover is an optional feature, which folds over itself, or back away from the front of the camera. The wrap is (for example) a flat sheet of material that is foldable or flexible. In one embodiment, the wrap is screwed into tripod mount (e.g. using female thread, case itself), or by clips or hooks (or alternatively, nothing holds it in place).

In one embodiment, the wrap is made of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band, net-shape material, magnetic material, metallic material, metallic sheet, metallic chain, array of metallic rings, 2-dimensional structure, multi-dimensional structure, flat structure, non-smooth plate, smooth plate, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar, compound, chemical, or composite material.

In one embodiment, the wrap includes (in, attached to, or on it) one or more of the following items: a picture frame, clock, notebook, calculator, solar cell array, battery, pen holder, pen, pencil, magnetic plate, magnetic decoration, light, LED, LCD, display, TV, radio, thermometer, pressure gauge, biometric sensor, thumb/fingerprint recognition module, combination lock, lock, password entry input, keyboard, input device, pointing device, speaker, microphone, telephone set, keychain ring, hook (for hanging the unit), video game, music player, downloading unit (from Internet or satellite), wireless unit, communication unit, antenna, small computer, small web browser, recorder, or any other electronic or mechanical device, apparatus, system, toy, decoration, or equipment.

Any other variation of the above teaching is also meant to be protected by the current patent.

1. A wrap cover for a camera, wherein said wrap cover comprises:
a connection device to connect said wrap cover to said camera,
wherein said wrap cover wraps around said camera, and
an attachment device to hold said wrap cover in place, wrapped around said camera.

2. A wrap cover for a camera as recited in claim 1, wherein said wrap cover wraps around said camera a fraction of a turn.

3. A wrap cover for a camera as recited in claim 1, wherein said wrap cover is integrated or compatible with a tripod.

4. A wrap cover for a camera as recited in claim 1, wherein said wrap cover is integrated or compatible with one or more of the following: an LCD shield or a lens shield.

5. A wrap cover for a camera as recited in claim 1, wherein said wrap cover is always connected to said camera through said connection device.

6. A wrap cover for a camera as recited in claim 1, wherein said wrap cover is used for cameras of different sizes or shapes.

7. A wrap cover for a camera as recited in claim 1, wherein said wrap cover is made of or comprised of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band, net-shape material, magnetic material, metallic material, metallic sheet, metallic chain, array of metallic rings, 2-dimensional structure, multi-dimensional structure, flat structure, non-smooth plate, smooth plate, folded structure, hinged objects, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any compound, chemical, or composite material.

8. A wrap cover for a camera as recited in claim 1, wherein the two ends of said wrap cover are partially or fully closed or sealed, to protect or cover the sides of said camera.

9. A wrap cover for a camera as recited in claim 1, wherein said attachment device or said connection device is or uses one or more of the following devices, methods, or items: chain, hook, Velcro, hook-and-loop, belt, adjustable belt, cable, string, tether, tie, binding means, magnet, screw, nut, nail, glue, temporary glue, knot, friction-based connector, connection means, elastic band, two extremely smooth surfaces, by electrostatic force or means, or by electromagnetic force or means.

10. A wrap cover for a camera as recited in claim 1, wherein said wrap cover is attached to a belt, pants, skirt, shirt, or purse.

11. A wrap cover for a camera as recited in claim 1, wherein on inside, edge, or outside surface of said wrap cover, one, two, or three-dimensional designs, text, or patterns are printed, marked, stamped, or engraved.

12. A wrap cover for a camera as recited in claim 1, wherein said wrap cover is used for decoration, advertisement, instructions, information, safety, protection, security, or convenience, for a user or said camera.

13. A wrap cover for a camera as recited in claim 1, wherein said wrap cover is attached to a base plate.

14. A wrap cover for a camera as recited in claim 1, wherein said wrap cover comprises an inverted bag.

15. A wrap cover for a camera as recited in claim 1, wherein said wrap cover comprises, connected to, or attached to one or more of the following items: a picture frame, clock, notebook, calculator, solar cell array, battery, pen holder, pen, pencil, magnetic plate, magnetic decoration, magnetic pieces, Velcro, hook-and-loop, dual lock, fastener, rubber band, light, LED, LCD, display, TV, radio, thermometer, pressure gauge, biometric sensor, thumb or fingerprint recognition module, combination lock, lock, password entry input, keyboard, input device, pointing device, speaker, microphone, telephone set, keychain ring, hook, video game, music player, downloading unit, wireless unit, communication unit, antenna, small computer, small web browser, voice, video, or picture recorder, or any electronic or mechanical device, apparatus, system, toy, decoration, or equipment.

16. A wrap cover for a camera as recited in claim 14, wherein said inverted bag is pulled up to cover said camera, and wherein said inverted bag is partially or fully-closed or sealed.

17. A wrap cover for a camera as recited in claim 1, wherein said wrap cover is used for cell phones and electronic devices.

18. A wrap cover for a camera as recited in claim 1, wherein said wrap cover is used for multiple cameras.

19. A wrap cover for a camera as recited in claim 1, wherein said wrap cover is adjustable for different-sized cameras.

20. A wrap cover for a camera as recited in claim 1, wherein said wrap cover wraps around said camera one turn or more than one turn.
